(19) United States
(12) Patent Application Publication
(10) Pub. No.: US 2013/0042748 A1
(43) Pub. Date: Feb. 21, 2013

(54) Mesostructure Based Scatterers in Helmet Suspension Pads

(71) Applicants: Alan Chun Ning Leung, Burke, VA (US); Peter Matic, Alexandria, VA (US)

(72) Inventors: Alan Chun Ning Leung, Burke, VA (US); Peter Matic, Alexandria, VA (US)

(73) Assignee: The Government of The United States of America, as represented by the Secretary of the Navy

(21) Appl. No.: 13/526,003

(22) Filed: Jun. 18, 2012

Related U.S. Application Data
(60) Provisional application No. 61/524,404, filed on Aug. 17, 2011.

(51) Int. Cl. F41H 1/04; B32B 3/12; B32B 5/32

(52) U.S. Cl. 89/36.02; 428/217; 428/188; 89/923

(57) ABSTRACT

A foam pad structure for helmets comprising a hard foam layer and a soft foam layer wherein the hard foam layer and the soft foam layer contain holes or channels scattered throughout the hard foam layer and the soft foam layer in a pattern so as to scatter an incoming pressure wave. A method of mitigating an incoming pressure wave comprising creating through-holes or channels in a soft foam layer, creating through-holes or channels in a hard foam layer, placing the hard foam layer inside a helmet shell, and placing the soft foam layer on the hard foam layer.

This application claims priority to and benefit of U.S. Patent Application No. 61/524,404 filed Aug. 17, 2011, the entirety of which is herein incorporated by reference.

### BACKGROUND

This disclosure provides for mitigating the propagation of pressure into the head from nonpenetrating blasts and provides support between the head and helmet of a soldier.

The current devices use a foam pad that provides support between the head and helmet of a soldier. The current foam pad is comprised of a hard foam layer and a soft foam layer.

Previous devices provide less mitigation of pressure into the head compared to the current invention with holes or channels placed in the foam pads. Holes or channels placed at the interface between hard foam and soft foam also mitigate the pressure over previous devices.

### BRIEF SUMMARY OF THE INVENTION

This disclosure provides for mesostructure based scatterers in helmet suspension pads. The foam pad is comprised of a hard foam layer and a soft foam layer. Cylindrical through-holes or channels located in the foam pad are designed to scatter the incoming pressure wave. The through-holes or channels can be placed at the interface to provide an additional mechanism for pressure wave scatter.

### BRIEF DESCRIPTION OF THE DRAWINGS

FIG. 1 illustrates a side view of a helmet with the foam pad invention. The foam pad contains one row of cylindrical through-holes or channels located between the hard foam pad and the soft foam pad.

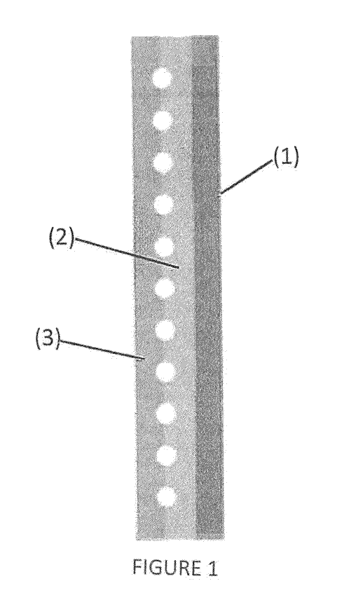

FIG. 2 illustrates several views. (a) illustrates a row of holes or channels at the interface of the hard and soft foam layers. (b) illustrates two rows of holes or channels: a first row in the soft foam layer and a second row in the hard foam layer. (c) illustrates three rows of holes or channels: a first row in the soft foam layer, a second row in the hard foam layer, and a third row at the interface of the hard and soft foam layers.

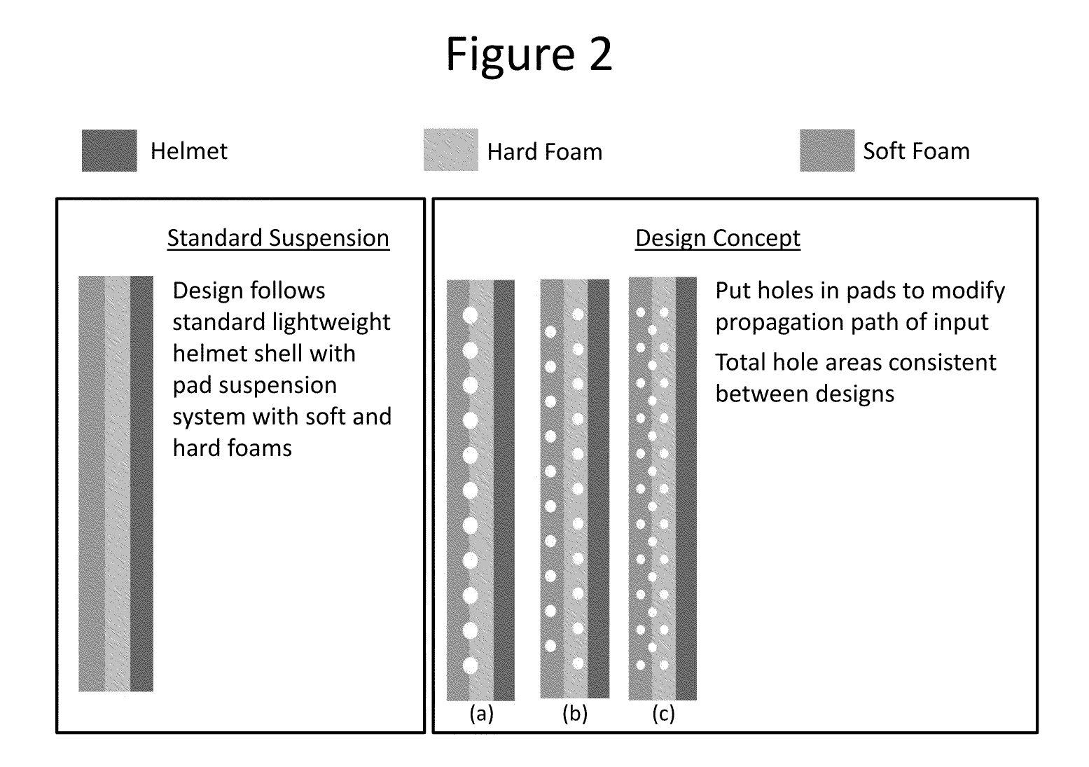

### DETAILED DESCRIPTION

The method disclosed provides for mesostructure based scatterers in helmet suspension pads. The invention concerns a helmet suspension foam pad designed to reduce the incoming pressure wave caused by non-penetrating blasts to the head.

The foam pad is comprised of a hard foam layer and a soft foam layer. Cylindrical through-holes or channels located in the foam pad are designed to scatter the incoming pressure wave. The through-holes or channels can be placed at the interface to provide an additional mechanism for pressure wave scatter. The invention can be attached to the helmet and placed onto the head and its orientation relative to the helmet and head can be as follows: the helmet shell, the hard foam layer, the soft foam layer and the head.

The abovementioned suspension pad design demonstrates the through-hole or channel scatterer design. Other suspension and helmet shell materials may be substituted. The through-holes or channels may also be placed at or away from a material interface.

The technique of low pass filtering and high pass filtering at different locations in the brain was used to characterize the performance between designs. The technique of taking the absolute integration of the pressure in time at different locations in the brain was also used to characterize the performance between designs.

The abovementioned suspension pad design demonstrates the through-hole or channel scatterer design. The placement of the holes, the number of holes, and the size of the holes in the foam pad can vary.

The through-holes or channels may also be placed at or away from a material interface. Different suspension materials may be used. Different helmet shell materials and designs may also be used with the invention.

This design adds functionality to the foam by introducing an impedance mismatch to the propagation of non-penetrating pressure waves that could come from a nearby blast. This design adds a multifunctional component to the protection provided by the helmet.

This disclosure vastly improves the existing suspension system by incorporating scatterers into the foam pads of specific hole or channel diameters and distributions to perform several functions. This disclosure teaches how to mitigate pressure infiltration into the brain, pressure which may lead to traumatic brain injuries (TBI). Furthermore, this approach continues to provide support for the helmet shell on the head.

The approach described herein is a simple design which adds no weight to burden the warfighter and furthermore is a cost effective solution to problems with the helmets currently in use.

This technology can be used in helmets in a variety of fields—motorcycle helmets, bicycle helmets, and fighter pilot helmets. The current foam pads only provide support between the helmet and the head. This disclosure teaches a simple method and structure to use the suspension pads in order to mitigate pressure into the brain from blunt trauma impacts or other pressure waves.

This scatterer pad design concept provides improved performance compared to standard designs. Low frequency pressure response is reduced by 36%. High frequency pressure response is reduced by 94%.

### Example 1

Using a typical helmet with a hard and soft foam, wherein the hard foam is placed between the soft foam and the helmet shell, holes or channels were cut in the hard and soft foam at the interface between the hard and soft foam components. This system consisted of one row of holes wherein the hole or channel diameter was 6.35 mm.

### Example 2

Using a typical helmet with a hard and soft foam, wherein the hard foam is placed between the soft foam and the helmet shell, holes or channels were cut in each of the hard foam and soft foam layers. This system comprised one row of holes or channels in the hard foam and one row of holes or channels in the soft foam in a manner wherein the holes or channels in the hard foam were parallel or nearly parallel to the plane of the length of the hard foam and one row of holes or channels in the soft foam in a manner wherein the holes or channels were parallel or nearly parallel to the plane of the length of the soft foam. The center to center distance in each row was 12.7 mm. The hole or channel diameter was 2.35 mm.

### Example 3

Using a typical helmet with a hard and soft foam, wherein the hard foam is placed between the soft foam and the helmet shell, holes or channels were cut in each of the hard foam and soft foam layers. This system comprised one row of holes or channels in the hard foam and one row of holes or channels in the soft foam in a manner wherein the holes or channels in the hard foam were parallel or nearly parallel to the plane of the length of the hard foam and one row of holes or channels in the soft foam in a manner wherein the holes or channels were parallel or nearly parallel to the plane of the length of the soft foam. The center to center distance in each row was 12.7 mm. Additionally, a row of holes or channels were cut in the hard and soft foam at the interface between the hard and soft foam components. The hole or channel diameter was 1.86 mm.

Many modifications and variations of the present invention are possible in light of the above teachings. It is therefore to be understood that the claimed invention may be practiced otherwise than as specifically described. Any reference to claim elements in the singular, e.g., using the articles “a,” “an,” “the,” or “said” is not construed as limiting the element to the singular.

What is claimed is:

1. A foam pad structure for helmets comprising:
a hard foam layer;
a soft foam layer;
wherein the hard foam layer has holes or channels scattered throughout the hard foam layer wherein the holes or channels are parallel or nearly parallel to the plane of the length of the hard foam and wherein the soft foam layer has holes or channels scattered throughout the soft foam layer wherein the holes or channels are parallel or nearly parallel to the plane of the length of the soft foam and wherein the holes or channels are positioned such that an incoming pressure wave impacting the foam pad structure is scattered.

2. The foam pad structure of claim 1 wherein the holes or channels are cylindrical.

3. The foam pad structure of claim 2 wherein the hole diameter is about 2.35 mm and the center to center distance in each row is about 12.7 mm.

4. The foam pad structure of claim 2 further including a row of holes or channels at the interface of the hard foam layer and the soft foam layer which provide an additional mechanism for pressure wave scatter.

5. The foam pad structure of claim 4 wherein the center to center distance in each row is about 12.7 mm.

6. The foam pad structure of claim 5 wherein the hole diameter is about 1.86 mm.

7. An apparatus for mitigating pressure into the brain from an incoming pressure wave comprising:
a helmet shell;
a hard foam layer;
a soft foam layer;
wherein the hard foam layer is between the helmet shell and the soft foam layer and wherein the interface between the hard foam layer and the soft foam layer comprise a row of holes or channels with a hole diameter of about 6.35 mm and a center to center distance of about 12.7 mm and wherein at an average peak pressure of about 8400 Pa for an incoming pressure wave reaching the helmet shell and propagating through the hard foam layer and the soft foam layer is reduced by about 44%.

8. The apparatus of claim 7 further including two more rows of holes or channels wherein a first row of holes or channels is in the hard foam layer along the length of the hard foam layer and a second row of holes or channels is in the soft foam layer along the length of the soft foam layer and wherein the hole diameter is about 1.86 mm and the center to center distance in each row is about 12.7 mm.

9. The apparatus of claim 8 wherein an incoming pressure wave of about 4700 Pa propagating through the helmet shell through the hard foam layer and through the soft foam layer is reduced by about 94%.

10. A method of mitigating an incoming pressure wave comprising:
creating through-holes or channels in a soft foam layer;
creating through-holes or channels in a hard foam layer;
placing the hard foam layer inside a helmet shell; and
placing the soft foam layer on the hard foam layer
wherein the holes or channels in the soft foam layer and the hard foam layer form a row of holes or channels that is parallel or nearly parallel to the interface between the soft foam layer and the hard foam layer.

11. The method of claim 10 wherein the holes or channels have a hole diameter of about 2.35 mm and a center to center distance in each row of about 12.7 mm.

12. The method of claim 10 further including creating a row of holes or channels along the interface between the soft foam layer and the hard foam layer.

13. The method of claim 12 wherein the holes or channels have a diameter of about 1.86 mm and further including the step of reducing an incoming pressure wave of about 4700 Pa to about 94% of the pressure.
